(19) United States
(12) Patent Application Publication
(10) Pub. No.: US 2025/0209925 A1
(43) Pub. Date: Jun. 26, 2025

(54) AERIAL IMAGING PLAN CREATION APPARATUS AND METHOD

(71) Applicant: FUJIFILM Corporation, Tokyo (JP)

(72) Inventor: Shinji HAYASHI, Tokyo (JP)

(73) Assignee: FUJIFILM Corporation, Tokyo (JP)

(21) Appl. No.: 19/073,344

(22) Filed: Mar. 7, 2025

Related U.S. Application Data
(63) Continuation of application No. PCT/JP2023/028671, filed on Aug. 7, 2023.

(30) Foreign Application Priority Data
Sep. 9, 2022 (JP) 2022-143779

(51) Int. Cl. G08G 5/32; G06V 20/10; G06V 20/17; G08G 5/57

(52) U.S. Cl. CPC G08G 5/32; G06V 20/17; G06V 20/176; G08G 5/57

(57) ABSTRACT

An aerial imaging plan creation apparatus includes a memory storing an aerial imaging plan that is set for aerially imaging an imaging region and that includes a flying route of a flying object and plural imaging points on the flying route, and a processor. The processor is configured to perform aerial imaging simulation of the imaging region in accordance with the aerial imaging plan stored in the memory and generate a simulation image corresponding to an actual aerially captured image through the aerial imaging simulation, for an object to be imaged in the imaging region, calculate ratio information indicating a ratio of an imageable region or a ratio of an unimageable region to an entire imaging region of the object to be imaged based on the simulation image, and evaluate the set aerial imaging plan based on the ratio information.

### CROSS-REFERENCE TO RELATED APPLICATIONS

The present application is a Continuation of PCT International Application No. PCT/JP2023/028671 filed on Aug. 7, 2023 claiming priority under 35 U.S.C § 119(a) to Japanese Patent Application No. 2022-143779 filed on Sep. 9, 2022. Each of the above applications is hereby expressly incorporated by reference, in its entirety, into the present application.

### BACKGROUND OF THE INVENTION

### 1. Field of the Invention

The present invention relates to an aerial imaging plan creation apparatus and a method, and particularly to a technique for creating an aerial imaging plan for favorable aerial imaging of an exterior of an object to be imaged with a small number of aerially captured images.

### 2. Description of the Related Art

In recent years, in order to perceive damage status at an occurrence of a disaster, imaging via a drone has been performed in addition to imaging via an aircraft in the related art.

Imaging of a house (a structure) via the aircraft is performed at a relatively high flying altitude (approximately 1000 m), so detailed damage status of each individual house cannot be perceived from an aerially captured image. Meanwhile, imaging via the drone is performed at a low altitude (150 m or lower), so detailed status of each individual house can be checked from the aerially captured image.

In order to check all houses in an imaging region, imaging in which a large number of overlapping portions (overlaps) are secured is generally performed. In this case, a problem arises in that the number of aerially captured images is increased, and checking requires time and labor. For example, while there has been widespread use of a technique for capturing a large number of images by securing a large number of overlapping portions, generating a three-dimensional model of an object to be imaged using a technique called structure from motion (SfM), and mapping an image of the object to be imaged to a surface of the three-dimensional model, SfM requires a long processing time, and processing an image obtained by imaging the imaging region of 500 m×500 m requires a time of several ten minutes or longer.

In the related art, an information processing apparatus that can acquire a large amount of information about a perpendicular view of a landform via a flying object by suppressing a decrease in imaging efficiency caused by the flying object has been suggested (JP2020-043543A).

The information processing apparatus according to JP2020-043543A generates a flying route for flying of the flying object, acquires landform information of a flying range in which the flying object flies, generates the flying route including an imaging position in a three-dimensional space for imaging the landform of the flying range based on the landform information of the flying range, and derives an imaging angle for each imaging position of the flying route based on the landform information of the flying range and on the flying route.

Particularly, in performing aerial imaging of an undulating ground surface via the flying object on which a camera is mounted, the information processing apparatus according to JP2020-043543A derives the imaging angle of the camera that enables aerial imaging of the ground surface to be performed as perpendicularly as possible (from a perpendicular side). Accordingly, even in a case where the ground surface is a slope surface of a mountain, the perpendicular view of the landform can be aerially captured, and a large amount of information about the perpendicular view of the landform can be acquired.

JP2021-196299A describes a flying plan creation system that creates a flying plan of an autonomously flying drone.

The flying plan creation system according to JP2021-196299A receives designation of an imaging region (a designated area) specified by latitude and longitude of a plurality of vertices, designation of latitude and longitude of a flying start point in the imaging region, designation of an angle of view and an altitude above ground level of a camera used for imaging, and designation of an overlap ratio and a sidelap ratio of imaging, and determines a flying line in the imaging region composed of a plurality of straight flying lines in accordance with various designated conditions. In a case where a difference in altitude between points to be passed after progress by a predetermined distance is greater than or equal to a predetermined value for the determined straight flying line, the altitude of the point to be passed at the current point of progress is corrected. Accordingly, in a case where the imaging region includes an undulating landform, the flying line and the point to be passed in the imaging region are automatically optimized.

### SUMMARY OF THE INVENTION

Any of the information processing apparatus or the flying plan creation system according to JP2020-043543A or JP2021-196299A creates a suitable aerial imaging plan in imaging the undulating ground surface (the imaging region) and does not create an aerial imaging plan for favorable aerial imaging of the exterior of the object to be imaged in the imaging region.

Particularly, the information processing apparatus according to JP2020-043543A derives the imaging angle of the camera for performing the aerial imaging of the ground surface perpendicularly. Thus, a problem arises in that only a roof can be imaged for a house on a flat land immediately below the camera.

The flying plan creation system according to JP2021-196299A optimizes the flying line and the point to be passed in the imaging region by receiving designation of the angle of view and the altitude above ground level of the camera and designation of the overlap ratio and the sidelap ratio of imaging. Thus, the flying plan (the aerial imaging plan) including the flying line and the point to be passed is determined by causing a user to designate a condition. The aerial imaging plan determined in this manner is not designed to optimize the number of aerially captured images and also does not consider favorable aerial imaging of the exterior of the object to be imaged in the imaging region.

The present invention has been conceived in view of such circumstances, and an object of the present invention is to provide an aerial imaging plan creation apparatus and a method capable of easily creating an aerial imaging plan for favorable aerial imaging of an exterior of an object to be imaged with a small number of aerially captured images.

In order to achieve the object, according to a first aspect of the invention, there is provided an aerial imaging plan creation apparatus comprising a memory storing an aerial imaging plan that is set for aerially imaging an imaging region and that includes a flying route of a flying object and a plurality of imaging points on the flying route, and a processor, in which the processor is configured to perform aerial imaging simulation of the imaging region in accordance with the aerial imaging plan stored in the memory and generate a simulation image corresponding to an actual aerially captured image through the aerial imaging simulation, for an object to be imaged in the imaging region, calculate ratio information indicating a ratio of an imageable region or a ratio of an unimageable region to an entire imaging region of the object to be imaged based on the simulation image, and evaluate the set aerial imaging plan based on the ratio information.

According to the first aspect of the present invention, the aerial imaging simulation of the imaging region is performed in accordance with the aerial imaging plan set in advance. Information (the ratio information) indicating whether or not the object to be imaged is suitably imaged is calculated. The set aerial imaging plan is evaluated based on the calculated ratio information. Thus, the aerial imaging plan can be evaluated in advance without actually performing aerial imaging of the imaging region.

According to a second aspect of the present invention, in the aerial imaging plan creation apparatus of the first aspect, the processor is preferably configured to acquire exterior information related to an exterior of the object to be imaged in the imaging region, and generate the simulation image based on three-dimensional information of the imaging point, camera information including a focal length and a posture of a camera mounted on the flying object, and the exterior information of the object to be imaged.

That is, in a case where the three-dimensional information of the imaging point on the flying route, the camera information of the camera mounted on the flying object, and the exterior information of the object to be imaged are already known, the simulation image corresponding to the actual aerially captured image in a case where the object to be imaged is imaged from the camera positioned at the imaging point can be generated.

According to a third aspect of the present invention, in the aerial imaging plan creation apparatus of the second aspect, it is preferable that the object to be imaged is a house, and the processor is configured to acquire latitude, longitude, and an altitude specifying a polygon of the house from a map database as the exterior information.

According to a fourth aspect of the present invention, in the aerial imaging plan creation apparatus of the first aspect, it is preferable that the object to be imaged is a house, and the processor is configured to calculate the ratio information of all houses in the imaging region.

According to a fifth aspect of the present invention, in the aerial imaging plan creation apparatus of the fourth aspect, in a case where the ratio information is an appearance ratio indicating the ratio of the imageable region to the entire imaging region of the house, the processor is preferably configured to, in a case where the number of houses in the imaging region is denoted by N, and the number of houses for which the appearance ratio greater than or equal to a first threshold value is calculated among the houses in the imaging region is denoted by Na, evaluate the set aerial imaging plan as being suitable in a case where Na/N is greater than or equal to a second threshold value.

According to a sixth aspect of the present invention, in the aerial imaging plan creation apparatus of the fifth aspect, the processor is configured to evaluate an aerial imaging plan that has Na/N greater than or equal to the second threshold value and that has highest Na/N within an allowable number of times of imaging, as being optimal.

According to a seventh aspect of the present invention, in the aerial imaging plan creation apparatus of the fourth aspect, the processor is preferably configured to generate a plurality of simulation images corresponding to the plurality of imaging points in accordance with the aerial imaging plan, calculate the ratio information of all houses in the plurality of simulation images, and in a case where a plurality of pieces of ratio information are calculated for the same house based on the plurality of simulation images, adopt ratio information indicating a largest imageable region among the plurality of pieces of ratio information as the ratio information of the same house.

In a case where the plurality of simulation images include the same house, a plurality of pieces of ratio information are calculated for the same house. In this case, the aerial imaging plan can be more suitably evaluated by setting the ratio information indicating the largest imageable region among the plurality of pieces of ratio information as the ratio information of the house.

According to an eighth aspect of the present invention, in the aerial imaging plan creation apparatus according to any one of the fourth to seventh aspects, the processor is preferably configured to, in calculating the ratio information of a specific house among the houses that are the objects to be imaged, calculate a ratio between a region of the specific house shown in the simulation image or a region of the specific house that is obstructed by a house in a foreground of the specific house and that is not shown in the simulation image, and a region of the specific house shown in the simulation image in a case where the specific house is not obstructed or is assumed not to be obstructed by the house in the foreground, as the ratio information.

According to a ninth aspect of the present invention, in the aerial imaging plan creation apparatus of the eighth aspect, the region of the house is preferably a region of an outer wall not including a roof.

This is because the region of the outer wall is easily acquired as the simulation image and is easily obstructed by the house in the foreground.

According to a tenth aspect of the present invention, in the aerial imaging plan creation apparatus of any one of the first to seventh aspects, the processor is preferably configured to select an aerial imaging plan evaluated as being optimal or suitable from a plurality of aerial imaging plans based on the evaluation.

According to an eleventh aspect of the present invention, in the aerial imaging plan creation apparatus of any one of the first to seventh aspects, it is preferable that the memory stores a plurality of aerial imaging plans, and the processor is configured to set the aerial imaging plan by automatically selecting a predetermined aerial imaging plan from the plurality of aerial imaging plans or receiving manual input of selection of the aerial imaging plan, and in a case where the set aerial imaging plan is evaluated as being unsuitable, select an aerial imaging plan having a larger number of times of imaging or an aerial imaging plan having a higher ratio of the imageable region of the object to be imaged than the set aerial imaging plan from the plurality of aerial imaging plans and set the selected aerial imaging plan again.

According to a twelfth aspect of the present invention, in the aerial imaging plan creation apparatus of any one of the first to seventh aspects, the processor is preferably configured to receive manual input of the aerial imaging plan including the flying route of the flying object and the plurality of imaging points on the flying route and store the received aerial imaging plan in the memory, and in a case where the aerial imaging plan stored in the memory is evaluated as being unsuitable, automatically correct the aerial imaging plan stored in the memory to an aerial imaging plan having a larger number of imaging points or an aerial imaging plan having a higher ratio of the imageable region of the object to be imaged than the aerial imaging plan stored in the memory and update the aerial imaging plan stored in the memory with the automatically corrected aerial imaging plan.

According to a thirteenth aspect of the invention, there is provided an aerial imaging plan creation method executed by an aerial imaging plan creation apparatus including a memory storing an aerial imaging plan that is set for aerially imaging an imaging region and that includes a flying route of a flying object and a plurality of imaging points on the flying route, and a processor, the method comprising, via the processor, a step of performing aerial imaging simulation of the imaging region in accordance with the aerial imaging plan stored in the memory and generating a simulation image corresponding to an actual aerially captured image through the aerial imaging simulation, a step of calculating, via the processor, for an object to be imaged in the imaging region, ratio information indicating a ratio of an imageable region or a ratio of an unimageable region to an entire imaging region of the object to be imaged based on the simulation image, and a step of evaluating the set aerial imaging plan based on the ratio information.

According to a fourteenth aspect of the present invention, in the aerial imaging plan creation method of the thirteenth aspect, it is preferable that, in the step of generating the simulation image, exterior information related to an exterior of the object to be imaged in the imaging region is acquired, and the simulation image is generated based on three-dimensional information of the imaging point, camera information including a focal length and a posture of a camera mounted on the flying object, and the exterior information of the object to be imaged.

According to a fifteenth aspect of the present invention, in the aerial imaging plan creation method of the thirteenth aspect, it is preferable that the object to be imaged is a house, and in the step of calculating the ratio information, the ratio information of all houses in the imaging region is calculated.

According to a sixteenth aspect of the present invention, in the aerial imaging plan creation method of the fifteenth aspect, in the step of calculating the ratio information, in a case where the ratio information is an appearance ratio indicating the ratio of the imageable region to the entire imaging region of the object to be imaged, the appearance ratios of all houses in the imaging region are calculated, and in the step of evaluating the aerial imaging plan, in a case where the number of houses in the imaging region is denoted by N, and the number of houses for which the appearance ratio greater than or equal to a first threshold value is calculated among the houses in the imaging region is denoted by Na, the set aerial imaging plan is evaluated as being suitable in a case where Na/N is greater than or equal to a second threshold value.

According to a seventeenth aspect of the present invention, in the aerial imaging plan creation method of the fifteenth aspect, it is preferable that, in the step of calculating the ratio information, the ratio information of all houses in a plurality of simulation images corresponding to the plurality of imaging points is calculated in accordance with the aerial imaging plan, and in a case where a plurality of pieces of ratio information are calculated for the same house based on the plurality of simulation images, ratio information indicating a largest imageable region among the plurality of pieces of ratio information is adopted as the ratio information of the same house.

According to an eighteenth aspect of the present invention, in the aerial imaging plan creation method of any one of the fifteenth to seventeenth aspects, in the step of calculating the ratio information, in calculating the ratio information of a specific house among the houses that are the objects to be imaged, a ratio between a region of the specific house shown in the simulation image or a region of the specific house that is obstructed by a house in a foreground of the specific house and that is not shown in the simulation image, and a region of the specific house shown in the simulation image in a case where the specific house is not obstructed or is assumed not to be obstructed by the house in the foreground is preferably calculated as the ratio information.

According to a nineteenth aspect of the present invention, in the aerial imaging plan creation method of the eighteenth aspect, the region of the house is preferably a region of an outer wall not including a roof.

According to a twentieth aspect of the present invention, in the aerial imaging plan creation method of any one of the thirteenth to seventeenth aspects, it is preferable that the memory stores a plurality of aerial imaging plans, the method further comprises a step of setting, via the processor, the aerial imaging plan by automatically selecting a predetermined aerial imaging plan from the plurality of aerial imaging plans or receiving manual input of selection of the aerial imaging plan, in the step of setting the aerial imaging plan, in a case where the set aerial imaging plan is evaluated as being unsuitable in the step of evaluating the aerial imaging plan, an aerial imaging plan having a larger number of times of imaging or an aerial imaging plan having a higher ratio of the imageable region of the object to be imaged than the set aerial imaging plan is set again from the plurality of aerial imaging plans, and the processor is configured to repeat execution of the step of generating the simulation image, the step of calculating the ratio information, and the step of evaluating the aerial imaging plan in accordance with the aerial imaging plan set again.

According to a twenty-first aspect of the present invention, in the aerial imaging plan creation method of any one of the thirteenth to seventeenth aspects, it is preferable that the method further comprises a step of receiving, via the processor, manual input of the aerial imaging plan including the flying route of the flying object and the plurality of imaging points on the flying route and storing the received aerial imaging plan in the memory, the processor is configured to, in a case where the aerial imaging plan stored in the memory is evaluated as being unsuitable, automatically correct the aerial imaging plan stored in the memory to an aerial imaging plan having a larger number of imaging points or an aerial imaging plan having a higher ratio of the imageable region of the object to be imaged than the aerial imaging plan stored in the memory and update the aerial imaging plan stored in the memory with the automatically corrected aerial imaging plan, and the processor is configured to repeat execution of the step of generating the simulation image, the step of calculating the ratio information, and the step of evaluating the aerial imaging plan in accordance with the updated aerial imaging plan.

According to the present invention, an aerial imaging plan for favorable aerial imaging of an exterior of an object to be imaged with a small number of aerially captured images can be easily created.

### BRIEF DESCRIPTION OF THE DRAWINGS

FIG. 1 is a schematic diagram illustrating a configuration example of a system including an aerial imaging plan creation apparatus according to an embodiment of the present invention.

FIG. 2 is a block diagram illustrating an embodiment of a hardware configuration of the aerial imaging plan creation apparatus illustrated in FIG. 1.

FIG. 3 is a functional block diagram illustrating a first embodiment of the aerial imaging plan creation apparatus according to the present invention.

FIG. 4 is a diagram illustrating an example of an imaging plan prepared in advance.

FIG. 5 is a diagram illustrating a relationship between an aerially captured image obtained by aerial imaging via a camera from an imaging point and a map showing a ground surface imaged in the aerially captured image.

FIG. 6 is a diagram illustrating a map including a house indicated by a rectangular frame.

FIG. 7 is a table showing exterior information of the house associated with a house ID.

FIG. 8 is a diagram used for describing a position and a posture of the camera.

FIG. 9 is a diagram illustrating a relationship between a three-dimensional space coordinate system having three axes corresponding to three-dimensional coordinates (x′, y′, Z) based on coordinate transformation in [Equation 1] and an image coordinate system of an image sensor of the camera.

FIG. 10 is a diagram illustrating an example of a simulation image corresponding to the aerially captured image.

FIGS. 11A to 11D are diagrams illustrating a first embodiment of a method of calculating an appearance ratio of the house.

FIGS. 12A to 12D are diagrams illustrating a second embodiment of the method of calculating the appearance ratio of the house.

FIG. 13 is a diagram illustrating processing of storing and updating the appearance ratio in association with the house ID.

FIG. 14 is a functional block diagram illustrating a second embodiment of the aerial imaging plan creation apparatus according to the present invention.

FIG. 15 is a flowchart illustrating an embodiment of an aerial imaging plan creation method according to the present invention.

### DESCRIPTION OF THE PREFERRED EMBODIMENTS

Hereinafter, preferred embodiments of an aerial imaging plan creation apparatus and a method according to the present invention will be described with reference to the accompanying drawings.

### [System Including Aerial Imaging Plan Creation Apparatus]

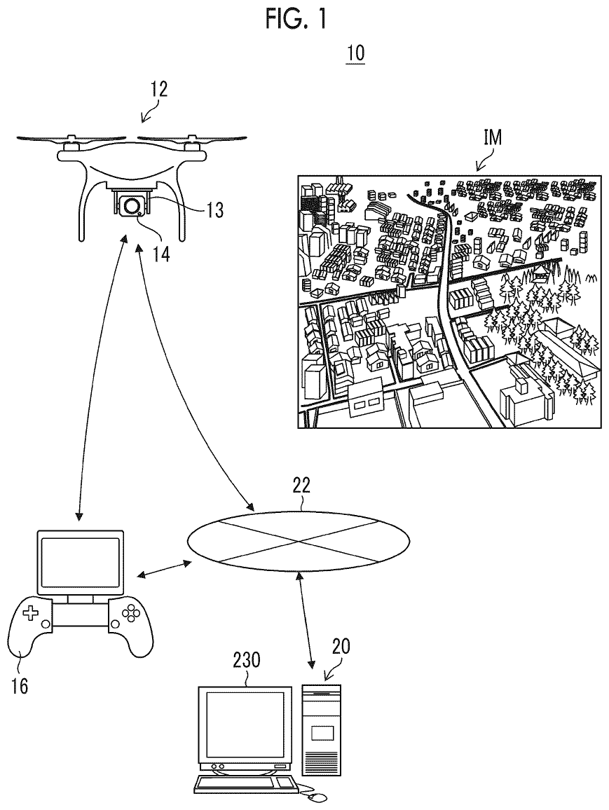

FIG. 1 is a schematic diagram illustrating a configuration example of a system including the aerial imaging plan creation apparatus according to the embodiment of the present invention.

A system 10 illustrated in FIG. 1 includes a drone 12 that is a flying object for aerial imaging, a remote controller 16, and an aerial imaging plan creation apparatus 20. The drone 12, the remote controller 16, and the aerial imaging plan creation apparatus 20 are connected to each other by a network 22. The aerial imaging plan creation apparatus 20 can connect to a map database of the Geospatial Information Authority of Japan (not illustrated) or a map database of OpenStreetMap through the network 22.

The drone 12 flies in accordance with an aerial imaging plan created by the aerial imaging plan creation apparatus 20 and automatically performs the aerial imaging of an imaging region at an imaging point on a flying route via a camera 14 mounted on the drone 12. The aerial imaging plan can be transmitted to the drone 12 from the aerial imaging plan creation apparatus 20 through the network 22 and the remote controller 16 that remotely operates the drone 12, directly transmitted to the drone 12 from the aerial imaging plan creation apparatus 20 through the network 22, or stored in advance in a memory (not illustrated) in the drone 12.

The aerial imaging plan can include the flying route of the flying object (the drone 12) set for the aerial imaging of the imaging region and a plurality of imaging points on the flying route and also include camera information of the camera 14 performing the aerial imaging. The camera information includes a focal length and a posture of the camera 14 during the aerial imaging. Details of the aerial imaging plan and the camera information will be described later.

In a case where a disaster occurs, the drone 12 performs the aerial imaging of the imaging region in order to investigate damage status of an object to be imaged in a region (the imaging region) in which the disaster occurs. In the present example, the object to be imaged is a house. The house is not limited to a house in which a person lives, and includes a factory, a store, a warehouse, and other buildings.

The camera 14 is mounted on the drone 12 through a gimbal head 13. The camera 14 or the drone 12 includes a global positioning system (GPS) receiver, an atmospheric pressure sensor, an azimuth sensor, a gyro sensor, and the like, acquires a position (latitude, longitude, and an altitude) of the camera 14 during the aerial imaging, sets a position on the flying route of the aerial imaging plan as a target position, and automatically flies by sequentially passing through the imaging points on the flying route.

In a case where the drone 12 reaches an imaging point on the flying route, the drone 12 stops in the air (hovers) and outputs an aerial imaging instruction to the camera 14. In a case where the camera 14 receives the aerial imaging instruction from the drone 12, the camera 14 performs the aerial imaging of the imaging region.

An image (hereinafter, referred to as an “aerially captured image IM”) captured using the camera 14 can be stored in a storage device such as an internal storage incorporated in the camera 14 and/or a memory card detachably mounted on the camera 14. The aerially captured image IM can be transmitted to the remote controller 16 or transmitted to the aerial imaging plan creation apparatus 20 using wireless communication. Information about the imaging point during the aerial imaging is preferably recorded in a header portion of an image file in which the aerially captured image IM is recorded.

The aerial imaging plan creation apparatus 20 is composed of a computer. The computer applied to the aerial imaging plan creation apparatus 20 may be a server, a personal computer, or a workstation.

The aerial imaging plan creation apparatus 20 can perform data communication with the drone 12, the remote controller 16, the external map database, and the like through the network 22. The network 22 may be a local area network or a wide area network.

The aerial imaging plan creation apparatus 20 can acquire the aerially captured image IM from the drone 12 or the camera 14 through the network 22 or the remote controller 16. The aerial imaging plan creation apparatus 20 can acquire the aerially captured image IM from the memory card or the like of the camera 14 without passing through the network 22. This is based on consideration of a case where a network in a part of the area is disabled because of the disaster.

### Summary of Present Invention

While the above operation of the system 10 is, for example, an operation in the aerial imaging of the drone 12 in accordance with the aerial imaging plan created by the aerial imaging plan creation apparatus 20 for the imaging region in order to investigate the damage status of the house in the region (the imaging region) in which the disaster occurs, a main function of the aerial imaging plan creation apparatus 20 is to evaluate the aerial imaging plan created and set in advance.

### (1) Setting of Aerial Imaging Plan

Which flying route is to be used for flying and which imaging point (latitude, longitude, and an altitude) is to be used for imaging are set for the imaging region (for example, 500 m×500 m). In this case, the focal length and the posture (an azimuthal angle and a depression angle indicating an imaging direction) of the camera 14 are determined in advance.

An area of the imaging region may be determined by specifications (a maximum flying time (battery-dependent), a maximum flying speed, and the like) of the drone 12.

The aerial imaging plan is set to image the same house in the imaging region a plurality of times in a plurality of aerially captured images corresponding to the number of imaging points. That is, the house in the imaging region is imaged from a plurality of different imaging points.

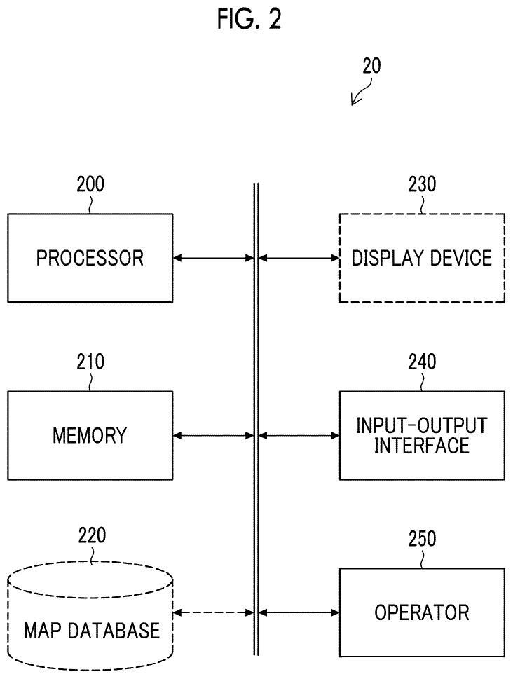

A plurality of aerial imaging plans having different flying routes and different imaging points are prepared in advance, and the plurality of prepared aerial imaging plans are stored in a memory 210 (FIG. 2) in the aerial imaging plan creation apparatus 20.

### (2) Evaluation of Aerial Imaging Plan

The aerial imaging plan creation apparatus 20 performs aerial imaging simulation in accordance with an aerial imaging plan set in (1) and generates a simulation image corresponding to an actual aerially captured image that is aerially captured at each imaging point, through the aerial imaging simulation. Details of generation of the simulation image will be described later.

For the house in the imaging region, the aerial imaging plan creation apparatus 20 calculates ratio information indicating a ratio of an imageable region (an appearance ratio) or a ratio of an unimageable region (an occlusion ratio) for the entire imaging region of the house based on the simulation image.

The appearance ratio of a specific house is a ratio of an actually imageable region that can be imaged unless a house in a foreground of the specific house in a view from the camera hinders imaging (unless the specific house is obstructed by the house in the foreground of the specific house), to the entire imaging region of the specific house. Accordingly, the appearance ratio of the specific house is 1 in a case where the house in the foreground of the specific house does not hinder imaging, and is 0 in a case where imaging cannot be performed at all because of the house hindering imaging.

Meanwhile, the occlusion ratio of a specific house is a ratio of a region (an unimageable region) that is obstructed by a house in a foreground of the specific house in a view from the camera and that can be imaged unless the house in the foreground hinders imaging, to the entire imaging region of the specific house. Accordingly, the occlusion ratio of the specific house is 0 in a case where the house in the foreground of the specific house does not hinder imaging, and is 1 in a case where imaging cannot be performed at all because of the house hindering imaging.

The present example uses the appearance ratio as the ratio information indicating the appearance ratio or the occlusion ratio of the house in the imaging region. However, since appearance ratio=1−occlusion ratio is established, the occlusion ratio may be used instead of the appearance ratio.

The aerial imaging plan creation apparatus 20 generates a plurality of simulation images corresponding to all imaging points through the aerial imaging simulation at all imaging points in the imaging region and calculates the appearance ratio of the house in each simulation image. In this case, since the aerial imaging plan is set to image the same house a plurality of times, a plurality of appearance ratios (a plurality of pieces of ratio information) are calculated for one house. However, the highest appearance ratio among the plurality of appearance ratios is adopted as the appearance ratio of the one house.

The aerial imaging plan creation apparatus 20 evaluates the aerial imaging plan set in (1) based on the appearance ratios of all houses in the imaging region calculated in the above manner.

In evaluating the aerial imaging plan, for example, the number of houses in the imaging region is denoted by N, and the number of houses for which the appearance ratio greater than or equal to a first threshold value is calculated among the houses in the imaging region is denoted by Na. An OK house ratio can be quantified as a value (Na/N) obtained by dividing the number of houses Na by the number of houses N.

### (3) Calculation of Optimal Aerial Imaging Plan

The aerial imaging plan creation apparatus 20 can perform the evaluation in (2) for the plurality of aerial imaging plans stored in the memory 210 and calculate the aerial imaging plan with the highest evaluation as the optimal aerial imaging plan.

The aerial imaging plan creation apparatus 20 can calculate the aerial imaging plan that satisfies the allowable number of aerially captured images set in advance and that has the highest OK house ratio, as the optimal aerial imaging plan. The aerial imaging plan having the OK house ratio exceeding a second threshold value (an allowable value) can be calculated as a suitable aerial imaging plan.

### [Hardware Configuration of Aerial Imaging Plan Creation Apparatus]

FIG. 2 is a block diagram illustrating an embodiment of a hardware configuration of the aerial imaging plan creation apparatus illustrated in FIG. 1.

The aerial imaging plan creation apparatus 20 illustrated in FIG. 2 comprises a processor 200, the memory 210, a map database 220, a display device 230, an input-output interface 240, and an operator 250.

The processor 200 is composed of a central processing unit (CPU) and the like, controls each unit of the aerial imaging plan creation apparatus 20 in an integrated manner, and performs simulation image generation processing of generating the simulation image, appearance ratio calculation processing, evaluation processing of the aerial imaging plan, and the like. Details of various types of processing of the processor 200 will be described later.

The memory 210 includes a flash memory, a read-only memory (ROM), a random access memory (RAM), a hard disk device, and the like. The flash memory, the ROM, or the hard disk device is a non-volatile memory storing various programs and the like including an operation system. The RAM functions as a work region of processing via the processor 200 and temporarily stores the programs and the like stored in the flash memory or the like. A part of the memory 210 (the RAM) may be incorporated into the processor 200.

The memory 210 stores the aerial imaging plan prepared in advance and, in a case where the aerially captured image IM is acquired in accordance with the aerial imaging plan, can store and manage the aerially captured image IM by functioning as an image storage unit storing the aerially captured image IM.

The map database 220 is a part that manages map information of the imaging region. In the present example, exterior information related to an exterior of the object to be imaged (the house) on a map is also managed in addition to the map.

Details of the exterior information related to the exterior of the house managed by the map database 220 will be described later. The map database 220 may be configured inside the aerial imaging plan creation apparatus 20 or may be an external map database accessible through the network 22. For example, the map database 220 may be the map database of the Geospatial Information Authority of Japan that manages base map information, or the map database of OpenStreetMap.

The display device 230 displays the aerial imaging plan to be evaluated, an evaluation result of an aerial imaging result, the simulation image, and the like in accordance with an instruction from the processor 200 and is also used as a part of a graphical user interface (GUI) in receiving various types of information from the operator 250.

The display device 230 may be included in the aerial imaging plan creation apparatus 20 or may be separately provided outside the aerial imaging plan creation apparatus 20 as illustrated in FIG. 1.

The input-output interface 240 includes a connection unit capable of connecting to an external apparatus, a communication unit capable of connecting to a network, and the like. A universal serial bus (USB), a high-definition multimedia interface (HDMI) (HDMI is a registered trademark), or the like can be applied as the connection unit capable of connecting to the external apparatus.

The operator 250 includes a pointing device such as a mouse, a keyboard, and the like and functions as a part of the GUI that receives various types of information and instructions input through a user operation.

### [Aerial Imaging Plan Creation Apparatus]

### <First Embodiment of Aerial Imaging Plan Creation Apparatus>

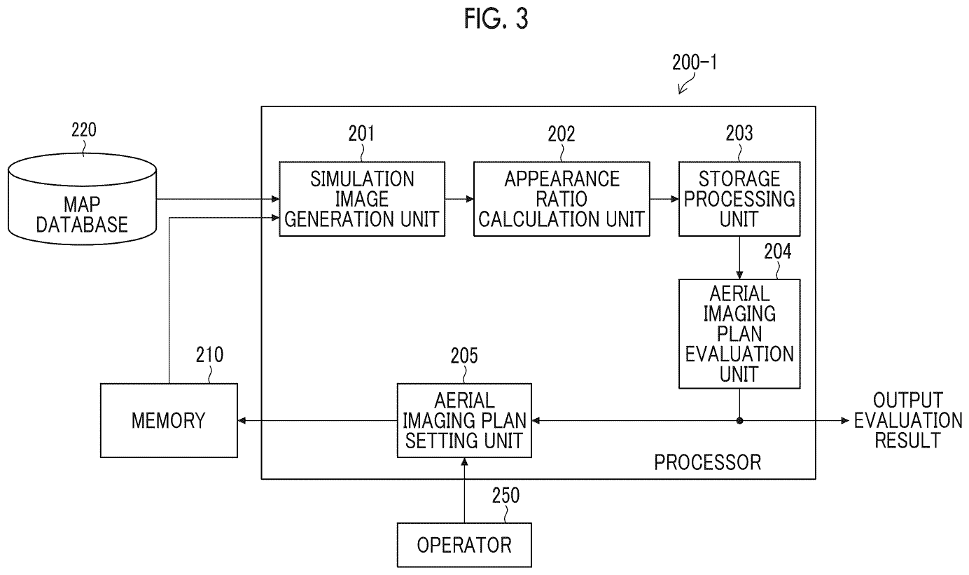

FIG. 3 is a functional block diagram illustrating a first embodiment of the aerial imaging plan creation apparatus according to the present invention.

FIG. 3 is a functional block diagram mainly illustrating functions of a processor 200-1 corresponding to the processor 200 of the aerial imaging plan creation apparatus 20 illustrated in FIG. 2.

In FIG. 3, the processor 200-1 functions as a simulation image generation unit 201, an appearance ratio calculation unit 202, a storage processing unit 203, an aerial imaging plan evaluation unit 204, and an aerial imaging plan setting unit 205.

The memory 210 of the present example stores the plurality of aerial imaging plans prepared in advance. The plurality of aerial imaging plans may have different flying routes and/or different imaging points for the imaging region.

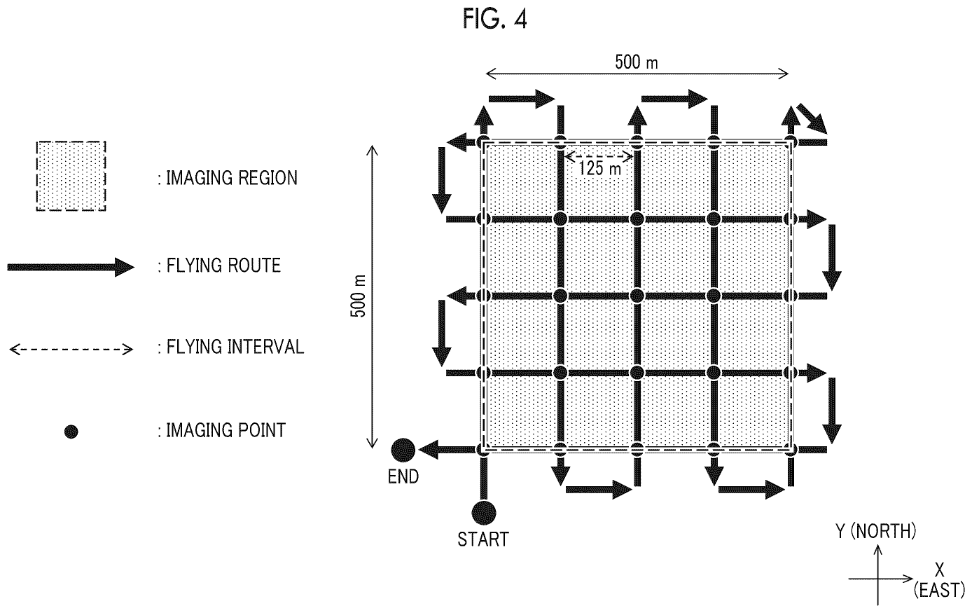

FIG. 4 is a diagram illustrating an example of the imaging plan prepared in advance.

In FIG. 4, the imaging region is a square region of 500 m×500 m indicated by a dotted line, and the flying route includes lattice-form flying routes indicated by thick arrows, which are flying routes for flying from a start to an end in the form of an Eulerian path. An interval (a flying interval) between adjacent flying routes in the lattice-form flying routes is 125 m. While the present example adopts the lattice-form flying routes, the present invention is not limited to this.

In the present example, the plurality of imaging points on the flying route are intersections at which the lattice-form flying routes intersect with each other. While there are 25 intersections, a total number of the imaging points is 50 because all intersections are passed twice. An interval between the imaging points is 125 m, which is the same as the flying interval. The interval between the imaging points may be smaller than 125 m. The imaging points preferably include the intersections of the lattice-form flying routes.

The lattice-form flying routes match an east-west direction and a south-north direction. In this case, the imaging region of 500 m×500 m can be specified by specifying a position (latitude and longitude) of the start of the flying route. For example, an altitude of the flying route can be set as a constant altitude of 150 m or lower. Accordingly, three-dimensional position (latitude, longitude, and altitudes) of the flying route and the imaging point can also be specified.

For an urban area divided into compartments in a lattice form, it is preferable that the imaging region corresponds to the compartments, and the flying route is set along the compartments. In this case, the imaging region of 500 m×500 m can be specified by specifying positions (latitude and longitude) of four corners of the imaging region.

Any of the plurality of aerial imaging plans stored in advance in the memory 210 is preferably set to image the same house in the imaging region a plurality of times based on the camera information of the camera 14 mounted on the drone 12.

The camera information indicates the focal length and the posture (the azimuthal angle and the depression angle indicating the imaging direction) of the camera 14 and is set in advance. The focal length of the camera 14 is a fixed focal length set in advance, and the posture of the camera 14 with respect to the drone 12 is also fixed. For example, the imaging direction of the camera 14 has a depression angle for imaging an oblique downward direction and is the same direction as a flying direction of the drone 12. In a case where the camera information of the camera 14 is changed, the aerial imaging plan also needs to be changed in accordance with the change camera information. This is because an imaging range of the aerially captured image captured by the camera 14 changes depending on the focal length of the camera 14.

In FIG. 3, the aerial imaging plan setting unit 205 selects an aerial imaging plan set in advance from the plurality of aerial imaging plans stored in the memory 210, reads out the selected aerial imaging plan from the memory 210, and transmits the read aerial imaging plan to the simulation image generation unit 201. In this case, the aerial imaging plan setting unit 205 can select and set an aerial imaging plan having the smallest number of imaging points (the smallest number of aerially captured images) among the plurality of aerial imaging plans.

The aerial imaging plan setting unit 205 may initially set the aerial imaging plan desired by a user by receiving manual input of selection of the aerial imaging plan from the operator 250.

In a case where the simulation image generation unit 201 acquires the aerial imaging plan to be evaluated from the memory 210, the simulation image generation unit 201 performs the aerial imaging simulation of the imaging region in accordance with the aerial imaging plan and generates the simulation image corresponding to the actual aerially captured image through the aerial imaging simulation.

In generating the simulation image, the simulation image generation unit 201 acquires the exterior information related to the exterior of the house in the imaging region, managed by the map database 220 and generates the simulation image corresponding to each aerially captured image obtained by the aerial imaging via the camera 14 from each imaging point, based on three-dimensional information (latitude, longitude, and an altitude) of each imaging point included in the aerial imaging plan, the camera information including the focal length and the posture of the camera 14 mounted on the drone 12, and the exterior information of the house acquired from the map database 220.

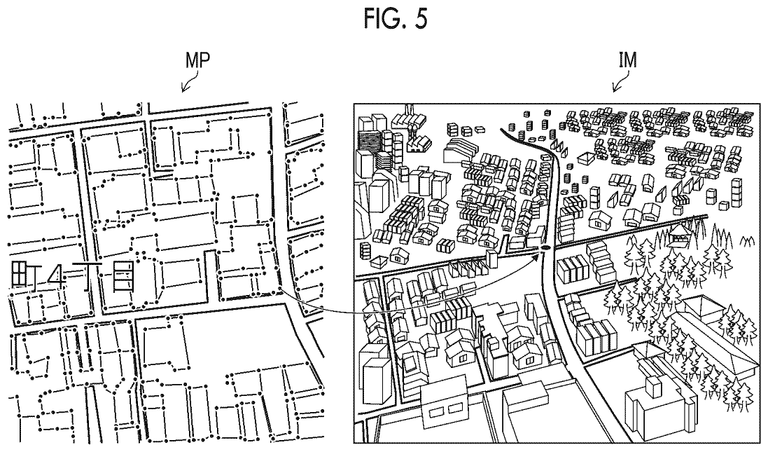

FIG. 5 is a diagram illustrating a relationship between the aerially captured image IM obtained by the aerial imaging via the camera 14 from an imaging point and a map MP showing a ground surface imaged in the aerially captured image IM.

In evaluating and creating the aerial imaging plan, the simulation image corresponding to the aerially captured image IM is generated without actually aerially capturing the aerially captured image IM. However, FIG. 5 illustrates the aerially captured image IM for convenience of description.

The simulation image generation unit 201 can predict an area (a block) of the aerially captured image IM obtained by the aerial imaging from the imaging point based on the three-dimensional information of the imaging point and on the camera information including the focal length and the posture of the camera 14, and acquires the map MP of the predicted area corresponding to the aerially captured image IM from the map database 220.

In FIG. 5, black circles on the map MP indicate vertices of a polygon of a ground outer periphery of the house and have three-dimensional information indicating latitude, longitude, and an altitude.

The simulation image generation unit 201 identifies positions of the vertices of the polygon indicated by the black circles on the map MP, on the simulation image corresponding to the aerially captured image IM.

In the map MP, a house identification (ID) as identification information for identifying each house is assigned to each individual house, and the latitude, the longitude, and the altitude of the vertex of the polygon of the ground outer periphery of the house are recorded in association with the house ID.

### <<Camera Matrix>>

A problem of obtaining a correspondence between three-dimensional space coordinates and two-dimensional image coordinates may be solved by obtaining a camera matrix as a transformation matrix of perspective projection transformation from the following equation based on a camera model.

Image coordinates (u, v)=camera matrix*three-dimensional coordinates (x, y, z)

The camera matrix can be represented by a product of an intrinsic parameter matrix and an extrinsic parameter matrix. The extrinsic parameter matrix is a matrix for transforming three-dimensional coordinates (world coordinates) into camera coordinates. The extrinsic parameter matrix is a matrix determined by the imaging point (the camera position) and the posture during the aerial imaging and includes a translation parameter and a rotation parameter.

The intrinsic parameter matrix is a matrix for transforming the camera coordinates into the image coordinates and is a matrix determined by specifications of the camera 14 such as the focal length of the camera and a sensor size and aberration (distortion) of an image sensor.

The three-dimensional coordinates (x, y, z) can be associated with (transformed into) the image coordinates (u, v) by transforming the three-dimensional coordinates (x, y, z) into the camera coordinates using the extrinsic parameter matrix and transforming the camera coordinates into the image coordinates (u, v) using the intrinsic parameter matrix.

The intrinsic parameter matrix can be specified in advance. Meanwhile, the extrinsic parameter matrix depends on the position and the posture of the camera and thus, needs to be set for each simulation image corresponding to the aerially captured image IM.

### <<Description of Perspective Projection Transformation Using Camera Matrix>>

The map MP and the exterior information related to the exterior of the object to be imaged (the house) included in the map MP are recorded in the map database 220.

That is, in the map MP, the house identification (ID) as the identification information for identifying each house is assigned to each individual house, and three-dimensional information of a plurality of specific points on the ground outer periphery of the house (the vertices of the polygon indicating the ground outer periphery of the house) is recorded in association with the house ID as the exterior information related to the exterior of the house. The three-dimensional information of the vertices of the polygon indicating the ground outer periphery of the house is information indicating latitude, longitude, and an altitude. Height information of the house may be recorded as the exterior information related to the exterior of the house.

The simulation image generation unit 201 acquires the three-dimensional information of the vertices of the polygon indicating the ground outer periphery of the house included in the map MP from the map database 220.

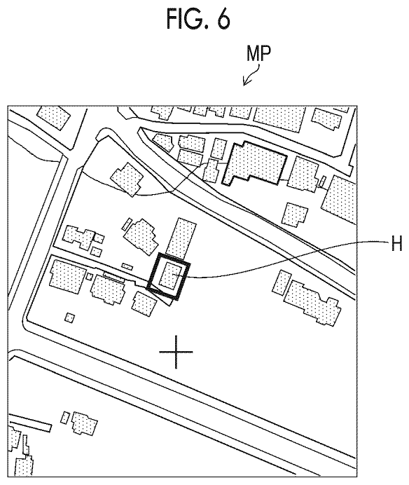

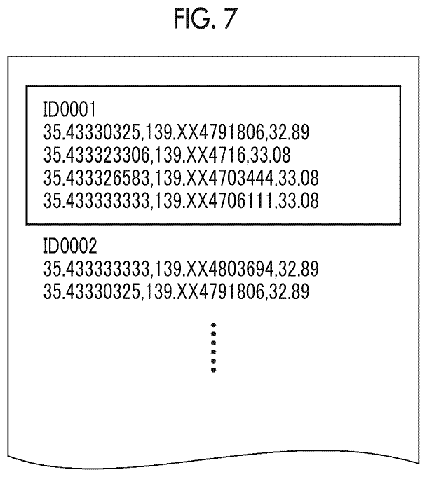

FIG. 6 is a diagram illustrating the map MP including a house H indicated by a rectangular frame, and FIG. 7 is a table showing the exterior information of the house associated with the house ID.

A polygon indicating a ground outer periphery of the house H illustrated in FIG. 6 has a quadrangular shape.

In FIG. 7, a house ID of the house H is ID0001, and latitude, longitude, and an altitude are recorded in association with ID0001 as three-dimensional information of four vertices of the polygon indicating the ground outer periphery of the house H.

A calculation method of transforming the three-dimensional coordinates (x, y, z) of the vertices of the polygon indicating the ground outer periphery of the house included in the map MP into coordinates (the image coordinates (u, v)) after being projected to the image sensor of the camera 14 will be described in detail.

In the three-dimensional coordinates (x, y, z) of the vertices of the polygon indicating the ground outer periphery of the house, x and y are obtained by transforming the latitude and the longitude into UTM coordinates, which are in an orthogonal coordinate system, and z denotes the altitude.

As shown in FIG. 7, the latitude, the longitude, and the altitude of the vertices of the polygon indicating the ground outer periphery of the house can be acquired from the map database 220 based on the house ID.

In a case where the height information of the house (a building) is recorded in the map database 220, a three-dimensional position of the lowest points of the roof on the image can be calculated using the height information. In a case where the height information is not present, for example, for a two-story house, an altitude of the lowest points of the roof may be calculated by assuming a height of the lowest points of the roof to be 6 m depending on a type of the house (a one-story house, a two-story house, a building (the number of stories of the building), or the like).

A three-dimensional position of the camera 14 during the aerial imaging is denoted by (xc, yc, zc). Here, xc and yc are obtained by transforming the latitude and the longitude of the imaging point into UTM coordinates, and zc denotes the altitude.

The posture (the imaging direction) of the camera 14 during the aerial imaging is specified by an azimuthal angle θh, a tilt angle θt, and a roll angle θr. The azimuthal angle θh is an angle from north with reference to north. The tilt angle θt is a camera angle (a depression angle) toward the ground. The roll angle θr is an inclination from the horizontal. In the present example, the posture of the camera 14 is fixed with respect to the gimbal head 13, and the imaging direction of the camera 14 during the aerial imaging is determined by the flying direction (the east-west direction or the south-north direction) of the drone 12.

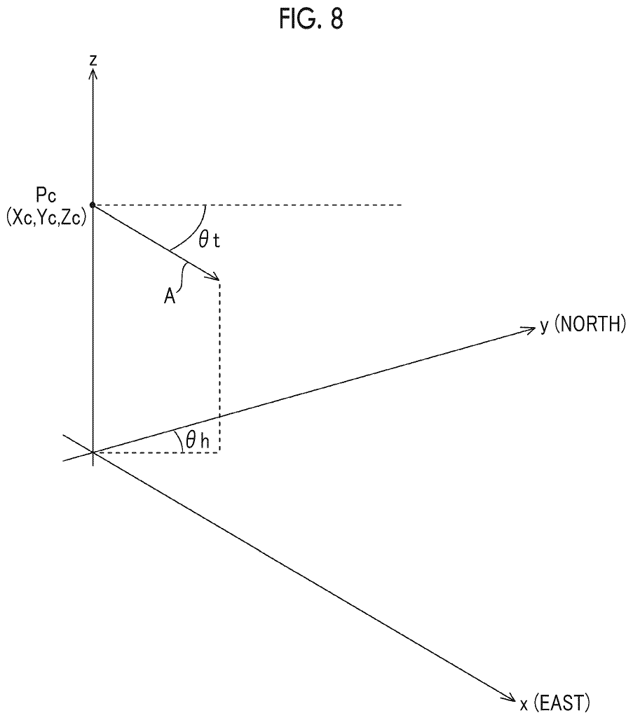

FIG. 8 is a diagram used for describing the position and the posture of the camera.

In a UTM coordinate system, an x axis is defined as east, and a y axis is defined as north. In FIG. 8, the position of the camera 14 is denoted by Pc(xc, yc, zc). Arrow A indicates the imaging direction specified by the posture of the camera 14.

An equation for transforming the coordinates (x, y, z) of the vertices of the polygon of the ground outer periphery of the house into an origin corresponding to a projection center (that is, an origin corresponding to the imaging point (the camera position) during the aerial imaging) is represented by [Equation 1].

$$( \begin{matrix}{x}^{′} \\ {y}^{′} \\ {z}^{′}\end{matrix} ) = ( \begin{matrix}x - xc \\ y - yc \\ z - zc\end{matrix} ) \qquad [ Equation l ]$$

Rotation matrices Mh, Mt, and Mr are defined by [Equation 2], [Equation 3], and [Equation 4].

$$Mh = ( \begin{matrix}cos ( θ h ) & - sin ( θ h ) & 0 \\ 0 & 0 & 1 \\ sin ( θ h ) & cos ( θ t ) & 0\end{matrix} ) \qquad [ Equation 2 ]$$

$$M t = ( \begin{matrix}1 & 0 & 0 \\ 0 & cos ( θ t ) & - sin ( θ t ) \\ 0 & sin ( θ t ) & cos ( θ t )\end{matrix} ) \qquad [ Equation 3 ]$$

$$M t = ( \begin{matrix}cos ( θ r ) & - sin ( θ r ) & 0 \\ sin ( θ r ) & cos ( θ r ) & 0 \\ 0 & 0 & 1\end{matrix} ) \qquad [ Equation 4 ]$$

In [Equation 2] to [Equation 4], the azimuthal angle θh, the tilt angle θt, and the roll angle θr indicating the imaging direction of the camera 14 are already known.

Coordinates (x′, y′, z′) of the vertices of the polygon with the projection center as the origin are transformed into camera coordinates using the following equation.

$$( \begin{matrix}X \\ Y \\ Z\end{matrix} ) = Mr * M t * Mh ( \begin{matrix}{x}^{′} \\ {y}^{′} \\ {z}^{′}\end{matrix} ) \qquad [ Equation 5 ]$$

An origin of the camera coordinates is the projection center. An X axis denotes a lateral direction of the image sensor. A Y axis denotes a longitudinal direction of the image sensor. A Z axis denotes a depth direction.

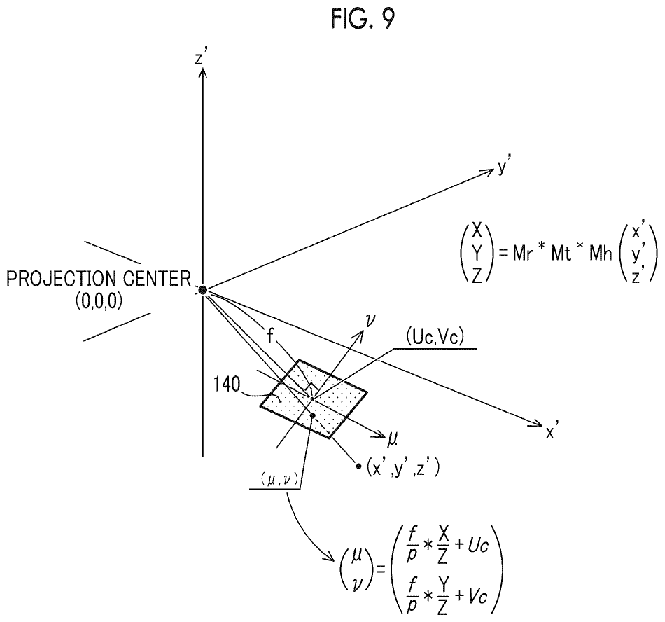

FIG. 9 is a diagram illustrating a relationship between a three-dimensional space coordinate system having three axes corresponding to the three-dimensional coordinates (x′, y′, z′) based on coordinate transformation in [Equation 1] and an image coordinate system of the image sensor of the camera 14.

Coordinates (X, Y, Z) (in meter units) of the vertices of the polygon obtained using [Equation 5] are transformed into camera coordinates (in pixel units) using the following equation.

$$( \begin{matrix}u \\ v\end{matrix} ) = ( \begin{matrix}\frac{f}{p} * \frac{X}{Z} + Uc \\ \frac{f}{p} * \frac{Y}{Z} + Vc\end{matrix} ) \qquad [ Equation 6 ]$$

In [Equation 6], f denotes the focal length of the camera 14, and p denotes a pixel pitch. The pixel pitch p is a distance between pixels of the image sensor and is normally common in the longitudinal direction and the lateral direction. Uc and Vc denote image center coordinates (in pixel units).

The simulation image generation unit 201 illustrated in FIG. 3 acquires the latitude, the longitude, and the altitude (FIG. 7) of the four vertices of the polygon of the ground outer periphery of the house H illustrated in FIG. 6 and performs operations of [Equation 1] to [Equation 6] based on the three-dimensional information of the imaging point and on the camera information including the focal length and the posture of the camera. Accordingly, the coordinates (x, y, z) of the four vertices of the polygon of the ground outer periphery of the house H can be associated with (subjected to the perspective projection transformation into) the image coordinates (u, v) of the camera coordinates.

The simulation image generation unit 201 generates the simulation image including the polygon of the ground outer periphery of the house H by connecting the four vertices of the polygon subjected to the perspective projection transformation into the image coordinates (u, v).

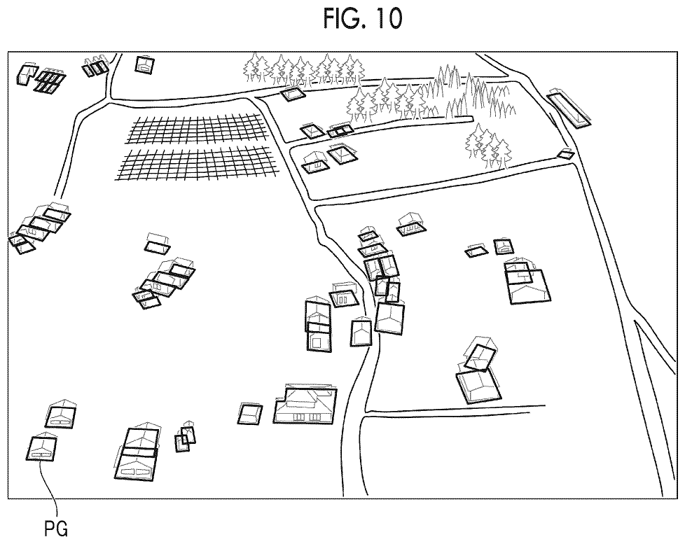

FIG. 10 is a diagram illustrating an example of the simulation image corresponding to the aerially captured image IM.

While FIG. 10 illustrates a state where the polygon (a polygon PG indicated by a thick frame) of the ground outer periphery of each house is displayed in a superimposed manner on the aerially captured image, the simulation image does not include the aerially captured image. This is because there is no aerially captured image that is actually aerially captured in accordance with the aerial imaging plan.

While FIG. 10 illustrates the polygon PG of the ground outer periphery of each house, a polygon indicating the exterior of each house is not illustrated because each house has a height.

Next, a polygon indicating an exterior of the house H will be described.

Latitude, longitude, and an altitude of vertices of the polygon indicating an outer periphery of the lowest points of a roof of the house H can be acquired by changing the altitude by a building height among the latitude, the longitude, and the altitude of the four vertices of the polygon indicating the ground outer periphery of the house H illustrated in FIG. 7. The building height of the house H can be acquired from the map database 220 based on the house ID of the house H. In a case where the map database 220 does not include building height information, the building height can be uniformly set to, for example, 6 m. The map database of the Geospatial Information Authority of Japan does not have the building height information. Thus, in a case where this map database is used as the map database 220, all building heights are assumed to be 6 m.

The simulation image generation unit 201 generates the simulation image by performing the perspective projection transformation of the vertices of the polygon indicating the outer periphery of the lowest points of the roof of the house H into image coordinates, in the same manner as that for the vertices of the polygon indicating the ground outer periphery of the house H.

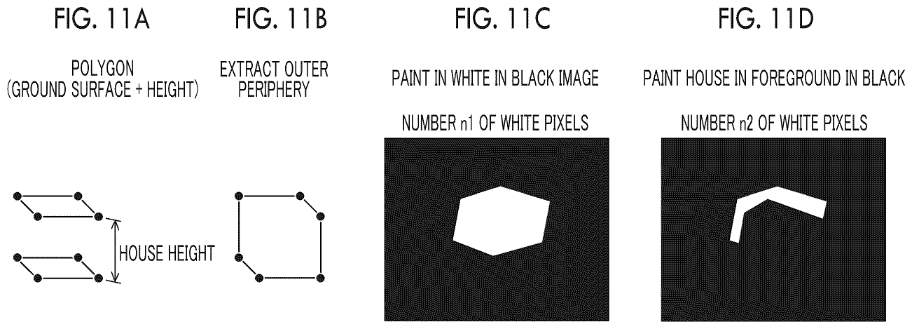

FIG. 11A illustrates the polygon indicating the ground outer periphery of the house H on the simulation image subjected to the perspective projection transformation and the polygon indicating the outer periphery of the lowest points of the roof of the house H. The polygon indicating the outer periphery of the lowest points of the roof of the house H is a polygon that is higher than the polygon indicating the ground outer periphery of the house H by the building height.

The simulation image generation unit 201 generates the polygon of the outer periphery indicating the exterior of the house H by connecting six points on the outermost periphery of eight points of the polygon illustrated in FIG. 11A (FIG. 11B). The simulation image generation unit 201 generates the simulation image by performing the perspective projection transformation of each vertex of the polygon of the outer periphery indicating the exterior of the house into image coordinates of the camera 14 and connecting the points on the outermost periphery of each house, for all houses in the aerially captured image IM obtained by the aerial imaging from the imaging point and the camera posture.

With reference to FIG. 3 again, the appearance ratio calculation unit 202 calculates the appearance ratio of each house based on the simulation image generated by the simulation image generation unit 201.

FIGS. 11A to 11D are diagrams illustrating a first embodiment of a method of calculating the appearance ratio of the specific house H.

In calculating the appearance ratio of the house H, the polygon of the outer periphery indicating the exterior of the house H is extracted from the simulation image (FIG. 11B), and a first black-and-white image obtained by painting a region of the polygon in white in a black image is acquired (FIG. 11C). The number (n1) of white pixels in the polygon painted in white in the first black-and-white image is counted.

Next, a second black-and-white image is acquired by painting a polygon of an outer periphery indicating an exterior of a house in a foreground of the house H in a view from the camera 14 in black in the first black-and-white image illustrated in FIG. 11C (FIG. 11D). The number (n2) of white pixels in the polygon painted in white in the second black-and-white image is counted.

A black region of a difference between the first black-and-white image illustrated in FIG. 11C and the second black-and-white image illustrated in FIG. 11D is a region in which the house H is not imaged because the house in the foreground hinders imaging. In a case where the house in the foreground does not hinder imaging, the first black-and-white image and the second black-and-white image match each other.

The appearance ratio calculation unit 202 calculates a ratio (n1/n2) of the number (n2) of white pixels of the second black-and-white image to the number (n1) of white pixels of the first black-and-white image as the appearance ratio of the house H.

The appearance ratio calculation unit 202 calculates the appearance ratios of all houses in the simulation image and outputs the appearance ratio to the storage processing unit 203 in association with the house ID.

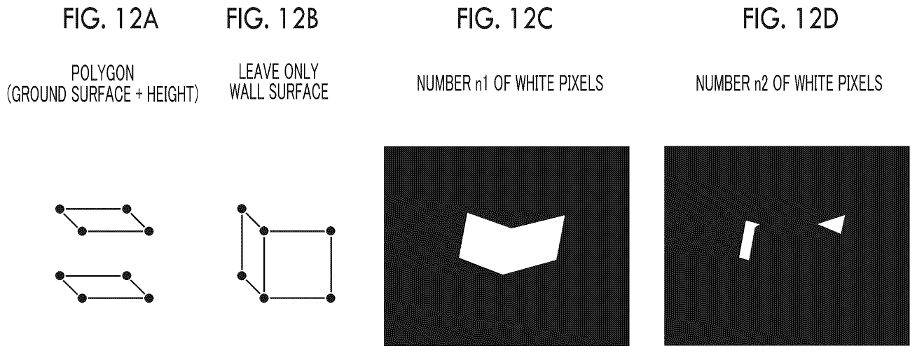

FIGS. 12A to 12D are diagrams illustrating a second embodiment of the method of calculating the appearance ratio of the specific house H.

The second embodiment of the method of calculating the appearance ratio as illustrated in FIGS. 12A to 12D is different from the first embodiment of the method of calculating the appearance ratio as illustrated in FIGS. 11A to 11D in that the appearance ratio is calculated by focusing on only a region of an outer wall of the house.

Six vertices corresponding to a region of an outer wall of the house H are selected from eight vertices of the polygon indicating the ground outer periphery of the house H and the polygon indicating the outer periphery of the roof of the house H illustrated in FIG. 12A, and a polygon indicating an outside region of the house H (the region of the outer wall not including the roof) is extracted by connecting the six vertices (FIG. 12B).

Next, the first black-and-white image obtained by painting the region of the polygon indicating the region of the outer wall in white in the black image is acquired (FIG. 12C), and the number (n1) of white pixels in the polygon painted in white in the first black-and-white image is counted.

Next, the second black-and-white image is acquired by painting the polygon of the outer periphery indicating the exterior of the house in the foreground of the house H in the view from the camera 14 in black in the first black-and-white image illustrated in FIG. 12C (FIG. 12D). The polygon of the outer periphery indicating the exterior of the house in the foreground is not the polygon indicating the region of the outer wall. The number (n2) of white pixels in the polygon painted in white in the second black-and-white image is counted.

The appearance ratio calculation unit 202 calculates the ratio (n1/n2) of the number (n2) of white pixels of the second black-and-white image illustrated in FIG. 12D to the number (n1) of white pixels of the first black-and-white image illustrated in FIG. 12C as the appearance ratio of the house H, in the same manner as the first embodiment of the method of calculating the appearance ratio as illustrated in FIGS. 11A to 11D.

The appearance ratio calculated in the above manner is an indicator of visibility of the outer wall of the house in the aerially captured image.

The appearance ratio calculation unit 202 of the present example calculates the appearance ratio of each house by applying the second embodiment of the method of calculating the appearance ratio as illustrated in FIGS. 12A to 12D.

The simulation image generation unit 201 illustrated in FIG. 3 generates the simulation image corresponding to the plurality of aerially captured images IM obtained by the aerial imaging from each imaging point and each camera posture in accordance with the aerial imaging plan. That is, the simulation image generation unit 201 generates the same number of simulation images as the number of imaging points set by the aerial imaging plan.

The appearance ratio calculation unit 202 calculates the appearance ratios of all houses in the simulation image for each of the same number of simulation images as the number of imaging points of the aerial imaging plan.

The storage processing unit 203 is a part storing the appearance ratio in association with the house ID and, in a case where a plurality of appearance ratios are calculated for the same house, adopts (stores) the highest appearance ratio among the plurality of appearance ratios as the appearance ratio of the same house.

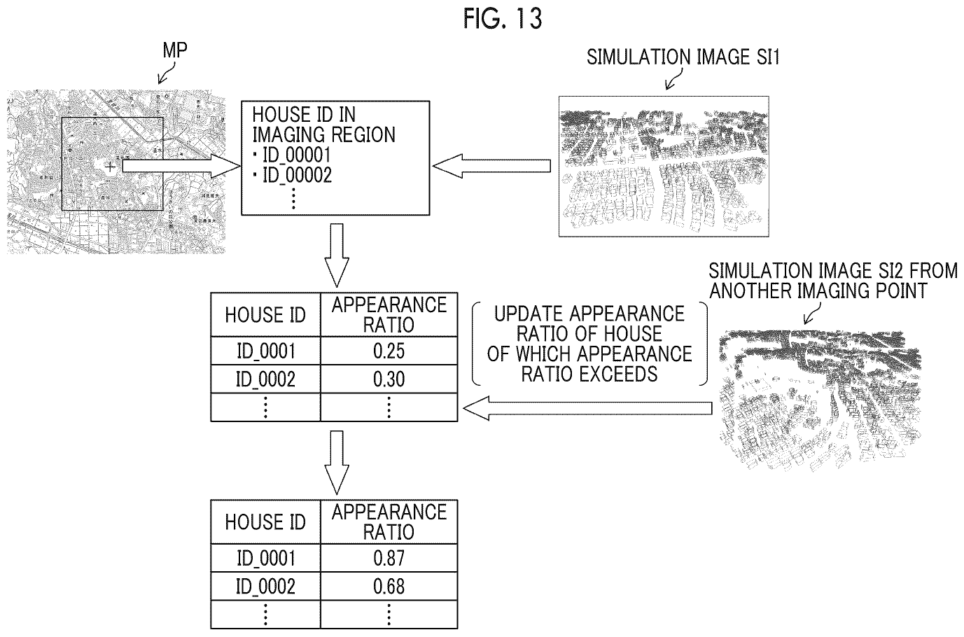

FIG. 13 is a diagram illustrating processing of storing and updating the appearance ratio in association with the house ID.

While the appearance ratio of each house in a simulation image SI1 is calculated by the appearance ratio calculation unit 202 as described above, the calculated appearance ratio of each house is recorded in the storage processing unit 203 in association with the house ID (ID_00001, ID_00002, . . . ) of each house included in the map MP.

In a case where the appearance ratio of each house in a simulation image SI2 is calculated based on the simulation image SI2 at another imaging point, the storage processing unit 203 stores the appearance ratio of each house calculated in the above manner in association with the house ID of each house included in the map MP.

In a case where the simulation image SI1 and the simulation image SI2 partially overlap with each other, the appearance ratio of the same house in the overlapping part is calculated in each of the simulation image SI1 and the simulation image SI2. In a case where the appearance ratio of the same house calculated based on the simulation image SI1 is already stored, and the appearance ratio of the same house among the appearance ratios calculated based on the simulation image SI2 exceeds the already stored appearance ratio, the storage processing unit 203 updates the stored appearance ratio. In the example illustrated in FIG. 13, each of the appearance ratios of the house IDs ID_00001 and ID_00002 is updated.

In a case where the plurality of appearance ratios are calculated for the same house, the storage processing unit 203 stores the highest appearance ratio among the plurality of appearance ratios as the appearance ratio of the same house by performing the processing of storing and updating the appearance ratio calculated based on each simulation image for the simulation images of all imaging points.

With reference to FIG. 3 again, in a case where the appearance ratios of all houses in the imaging region (in the present example, 500 m×500 m) are calculated, the aerial imaging plan evaluation unit 204 evaluates the current aerial imaging plan to be evaluated based on the appearance ratios of all houses.

Hereinafter, an example of evaluation of the aerial imaging plan via the aerial imaging plan evaluation unit 204 will be described.

The aerial imaging plan evaluation unit 204 counts the number of houses in the imaging region as N and counts the number of houses for which the appearance ratio greater than or equal to the first threshold value is calculated among the houses in the imaging region as Na. For example, the first threshold value can be set to 0.8.

The aerial imaging plan evaluation unit 204 calculates the ratio (Na/N) of the number Na of houses for which the appearance ratio greater than or equal to the first threshold value is calculated to the number N of houses in the imaging region, and sets Na/N as the OK house ratio.

The aerial imaging plan evaluation unit 204 can set the OK house ratio as an evaluation value of the aerial imaging plan. The aerial imaging plan evaluation unit 204 can determine the aerial imaging plan to be evaluated as being suitable in a case where the OK house ratio is greater than or equal to a threshold value (the second threshold value), and determine the aerial imaging plan to be evaluated as being unsuitable in a case where the OK house ratio is less than the second threshold value, and can output this determination result. The determination result is not limited to two-level evaluation of suitable/unsuitable and can be obtained by five-level evaluation or the like.

The aerial imaging plan having a large number of times of imaging has a higher OK house ratio (Na/N) than the aerial imaging plan having a small number of times of imaging. Meanwhile, the aerial imaging plan having a large number of times of imaging poses a problem in that a time required for the actual aerial imaging and a processing time of the aerially captured image are increased. Therefore, it is preferable to create the aerial imaging plan that has the OK house ratio (Na/N) satisfying a reference value (the second threshold value) and that has a small number of times of imaging.

In order to create the optimal aerial imaging plan in accordance with the above condition, the aerial imaging plan setting unit 205 sets the aerial imaging plan as follows.

First, in a case where the aerial imaging plan evaluation unit 204 determines that the current aerial imaging plan to be evaluated is unsuitable, the aerial imaging plan setting unit 205 selects an aerial imaging plan having a higher OK house ratio (Na/N) than the current aerial imaging plan to be evaluated from the plurality of aerial imaging plans stored in the memory 210. For example, an aerial imaging plan having a larger number of imaging points than the current aerial imaging plan to be evaluated is selected.

The selected aerial imaging plan is output to the simulation image generation unit 201. The simulation image generation unit 201, the appearance ratio calculation unit 202, the storage processing unit 203, and the aerial imaging plan evaluation unit 204 perform generation of the simulation image, calculation of the appearance ratio based on the generated simulation image, processing of storing the calculated appearance ratio, and evaluation of the aerial imaging plan based on the stored appearance ratio, respectively, in the same manner as that for the initially set aerial imaging plan.

The aerial imaging plan evaluation unit 204 can adopt the aerial imaging plan having the OK house ratio (Na/N) satisfying the reference value and output the aerial imaging plan together with the evaluation result.

The aerial imaging plan evaluation unit 204 can determine the aerial imaging plan having the highest OK house ratio (Na/N) within an allowable number of times of imaging as being optimal, or determine the aerial imaging plan having the smallest number of times of imaging while the OK house ratio (Na/N) satisfies the reference value as being optimal. The aerial imaging plan having the smallest number of times of imaging among the aerial imaging plans having the OK house ratio (Na/N) of 1 or a value close to 1 can be determined as being optimal.

The aerial imaging plan evaluation unit 204 may evaluate the aerial imaging plan using a representative value (for example, an average value) of the appearance ratios of all houses in the imaging region without using the OK house ratio (Na/N).

The aerial imaging plan evaluation unit 204 can receive input of the specifications (the maximum flying time (battery-dependent), the maximum flying speed, and the like) of the drone 12 and, in a case where the specifications of the drone 12 are constrained, include a length of the flying route as one of evaluation criteria.

As described above, the aerial imaging plan can be evaluated without actually performing the aerial imaging in accordance with the aerial imaging plan using the drone 12, and the aerial imaging plan for favorable aerial imaging of the exterior of the object to be imaged (the house) with a small number of aerially captured images can be easily created.

### <Second Embodiment of Aerial Imaging Plan Creation Apparatus>

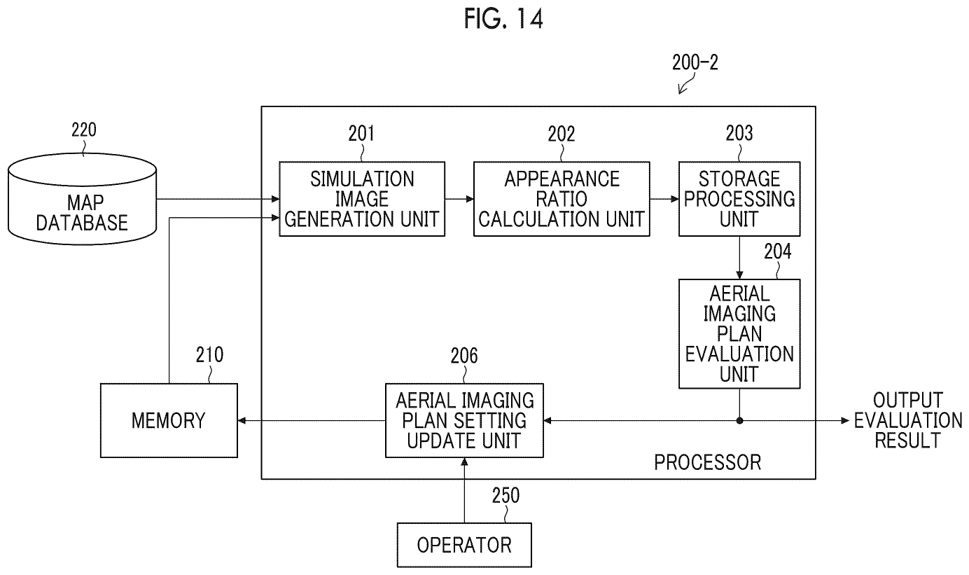

FIG. 14 is a functional block diagram illustrating a second embodiment of the aerial imaging plan creation apparatus according to the present invention.

FIG. 14 is a functional block diagram mainly illustrating functions of a processor 200-2 corresponding to the processor 200 of the aerial imaging plan creation apparatus 20 illustrated in FIG. 2. Parts common to the first embodiment of the aerial imaging plan creation apparatus illustrated in FIG. 3 are designated by the same reference numerals in FIG. 14 and will not be described in detail.

The processor 200-2 of the aerial imaging plan creation apparatus 20 of the second embodiment illustrated in FIG. 14 is different in that an aerial imaging plan setting update unit 206 is provided instead of the aerial imaging plan setting unit 205 illustrated in FIG. 3.

The aerial imaging plan setting update unit 206 receives manual input of the aerial imaging plan from the operator 250 and stores the received aerial imaging plan in the memory 210 as the initial aerial imaging plan to be evaluated. The aerial imaging plan setting update unit 206 may store a default aerial imaging plan or a previously created aerial imaging plan in the memory 210 as the initial aerial imaging plan to be evaluated.

The aerial imaging plan to be evaluated stored in the memory 210 is output to the simulation image generation unit 201.

The simulation image generation unit 201, the appearance ratio calculation unit 202, the storage processing unit 203, and the aerial imaging plan evaluation unit 204 perform generation of the simulation image, calculation of the appearance ratio based on the generated simulation image, processing of storing the calculated appearance ratio, and evaluation of the aerial imaging plan based on the stored appearance ratio, in the same manner as the first embodiment based on the aerial imaging plan to be evaluated stored in the memory 210.

In a case where the evaluation result is unsuitable based on the evaluation result of the aerial imaging plan to be evaluated provided by the aerial imaging plan evaluation unit 204, the aerial imaging plan setting update unit 206 automatically corrects the current aerial imaging plan to be evaluated to obtain a suitable evaluation result and rewrites the aerial imaging plan stored in the memory 210 with the automatically corrected aerial imaging plan.

For example, in a case where the OK house ratio (Na/N) is lower than the reference value, the aerial imaging plan setting update unit 206 corrects the current imaging plan to increase the number of imaging points or to increase the number of imaging points and reduce the flying interval, and rewrites the aerial imaging plan stored in the memory 210 with the corrected aerial imaging plan.

Conversely, in a case where the OK house ratio (Na/N) is significantly higher than the reference value, the aerial imaging plan setting update unit 206 corrects the current imaging plan to reduce the number of imaging points or to reduce the number of imaging points and increase the flying interval, and rewrites the aerial imaging plan stored in the memory 210 with the corrected aerial imaging plan. According to this, optimization that minimizes an imaging time of the aerially captured image and the number of times of imaging can be performed.

### [Embodiment of Aerial Imaging Plan Creation Method]

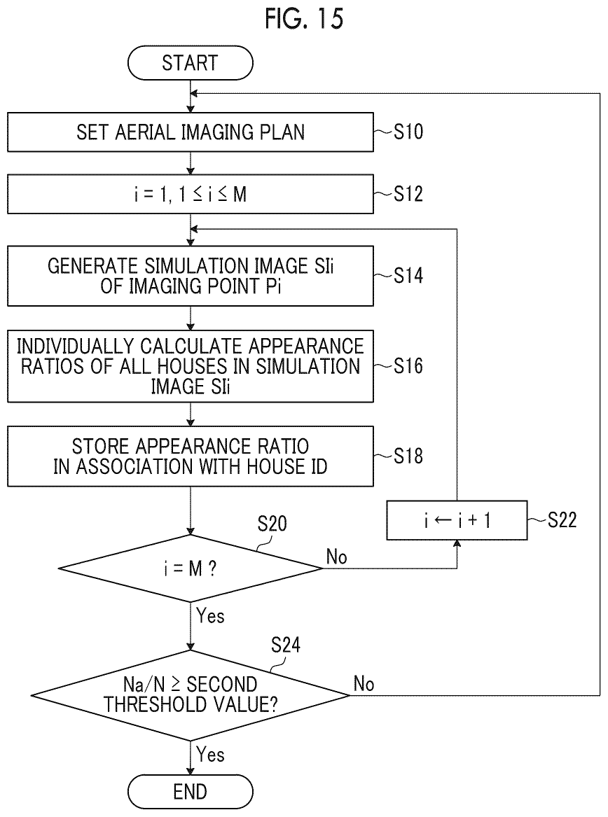

FIG. 15 is a flowchart illustrating an embodiment of an aerial imaging plan creation method according to the present invention.

The aerial imaging plan creation method illustrated in FIG. 15 is a method performed by the aerial imaging plan creation apparatus of the first embodiment illustrated in FIG. 3.

In FIG. 15, in initially setting the aerial imaging plan to be evaluated, the processor 200-1 sets the aerial imaging plan by automatically selecting a predetermined aerial imaging plan from the plurality of aerial imaging plans stored in the memory 210 or receiving manual input of selection of the aerial imaging plan (step S10).

Next, a parameter i indicating an imaging point Pi in the aerial imaging plan is set to 1 (step S12). A total number of imaging points is denoted by M.

The processor 200-1 generates a simulation image SIi of the imaging point Pi (step S14). The simulation image SIi can be generated based on three-dimensional information (latitude, longitude, and an altitude) of the imaging point Pi, the camera information including the focal length and the posture of the camera 14 mounted on the drone 12, and the exterior information of each house (the latitude, the longitude, and the altitude of the vertices of the polygon of the ground outer periphery of the house) acquired from the map database 220.

Next, the processor 200-1 individually calculates the appearance ratios of all houses included in the simulation image SIi based on the simulation image SIi (step S16). In the present example, an appearance ratio of the outer wall of each house is adopted as the appearance ratio of the house.

The processor 200-1 stores the appearance ratio of each house calculated in step S16 in association with the house ID (step S18).

Whether or not the parameter i is M is determined (step S20), and in a case where the parameter i is not M, the parameter i is incremented by 1 (step S22), and the processor 200-1 returns to step S14.

Accordingly, the processing of steps S14 to S20 is repeated for the next imaging point Pi. In step S18, in a case where the appearance ratio of the same house ID is stored, and the appearance ratio exceeds the stored appearance ratio, the stored appearance ratio is updated.

In step S20, in a case where it is determined that the parameter i is M (in a case where the processing of steps S14 to S18 is finished for all imaging points), the processor 200-1 evaluates the current aerial imaging plan to be evaluated set in step S10 based on the appearance ratios of all houses in the imaging region.

In the present example, the processor 200-1 counts the number of houses in the imaging region as N and counts the number of houses for which the appearance ratio greater than or equal to the first threshold value is calculated among the houses in the imaging region as Na. For example, the first threshold value can be set to 0.8.

The ratio (Na/N) of the number Na of houses for which the appearance ratio greater than or equal to the first threshold value is calculated to the number N of houses in the imaging region is calculated, and Na/N is set as the OK house ratio. The processor 200-1 determines whether or not the OK house ratio (Na/N) is greater than or equal to the second threshold value (step S24), and in a case where it is determined that the OK house ratio (Na/N) is less than the second threshold value (“No”), evaluates the aerial imaging plan to be evaluated as being unsuitable and returns to step S10.

The processor 200-1 sets the aerial imaging plan having the OK house ratio (Na/N) higher than the aerial imaging plan evaluated as being unsuitable, again among the plurality of aerial imaging plans stored in the memory 210 and repeats the processing of steps S12 to S24.

Meanwhile, in step S24, in a case where it is determined that the OK house ratio (Na/N) is greater than or equal to the second threshold value (“Yes”), the aerial imaging plan to be evaluated is evaluated as being suitable, and the present processing is finished.

### [Other]

The aerial imaging plan setting update unit 206 may automatically correct the aerial imaging plan by providing an instruction to further improve the appearance ratio of the house in a region of interest for the aerial imaging plan to be evaluated. The aerial imaging plan may be evaluated with reference to not only the appearance ratio of the outer wall of each house but also “the number of outer walls seen”, “the lowest appearance ratio of the outer walls seen”, and the like.

In the present embodiment, for example, a hardware structure of a processing unit such as a central processing unit (CPU) that executes various types of processing includes various processors illustrated below. The various processors include a CPU that is a general-purpose processor functioning as various processing units by executing software (a program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs or a combination of a CPU and an FPGA). A plurality of processing units may be composed of one processor. A first example of the plurality of processing units composed of one processor is, as represented by a computer such as a client and a server, one processor composed of a combination of one or more CPUs and software, in which the processor functions as the plurality of processing units. A second example is, as represented by a system on chip (SoC) and the like, use of a processor that implements functions of the entire system including the plurality processing units in one integrated circuit (IC) chip. Accordingly, various processing units are composed of one or more of the various processors as their hardware structures.

The hardware structure of the various processors is more specifically an electric circuit (circuitry) in which circuit elements such as semiconductor elements are combined.

The present invention is not limited to the embodiment and can be subjected to various modifications without departing from the spirit of the present invention.

### EXPLANATION OF REFERENCES

10: system
12: drone
13: gimbal head
14: camera
16: remote controller
20: aerial imaging plan creation apparatus
22: network
200: processor
200-1: processor
200-2: processor
201: simulation image generation unit
202: appearance ratio calculation unit
203: storage processing unit
204: aerial imaging plan evaluation unit
205: aerial imaging plan setting unit
206: aerial imaging plan setting update unit
210: memory
220: map database
230: display device
240: input-output interface
250: operator
H: house
IM: aerially captured image
MP: map
S10 to S24: step
SI1, SI2, SIi: simulation image

What is claimed is:

1. An aerial imaging plan creation apparatus comprising:
a memory storing an aerial imaging plan that is set for aerially imaging an imaging region and that includes a flying route of a flying object and a plurality of imaging points on the flying route; and
a processor,
wherein the processor is configured to:
perform aerial imaging simulation of the imaging region in accordance with the aerial imaging plan stored in the memory and generate a simulation image corresponding to an actual aerially captured image through the aerial imaging simulation;
for an object to be imaged in the imaging region, calculate ratio information indicating a ratio of an imageable region or a ratio of an unimageable region to an entire imaging region of the object to be imaged based on the simulation image; and
evaluate the set aerial imaging plan based on the ratio information.

2. The aerial imaging plan creation apparatus according to claim 1,
wherein the processor is configured to:
acquire exterior information related to an exterior of the object to be imaged in the imaging region; and
generate the simulation image based on three-dimensional information of the imaging point, camera information including a focal length and a posture of a camera mounted on the flying object, and the exterior information of the object to be imaged.

3. The aerial imaging plan creation apparatus according to claim 2,
wherein the object to be imaged is a house, and
the processor is configured to acquire latitude, longitude, and an altitude specifying a polygon of the house from a map database as the exterior information.

4. The aerial imaging plan creation apparatus according to claim 1,
wherein the object to be imaged is a house, and
the processor is configured to calculate the ratio information of all houses in the imaging region.

5. The aerial imaging plan creation apparatus according to claim 4,
wherein, in a case where the ratio information is an appearance ratio indicating the ratio of the imageable region to the entire imaging region of the house, the processor is configured to, in a case where the number of houses in the imaging region is denoted by N, and the number of houses for which the appearance ratio greater than or equal to a first threshold value is calculated among the houses in the imaging region is denoted by Na, evaluate the set aerial imaging plan as being suitable in a case where Na/N is greater than or equal to a second threshold value.

6. The aerial imaging plan creation apparatus according to claim 5,
wherein the processor is configured to evaluate an aerial imaging plan that has Na/N greater than or equal to the second threshold value and that has highest Na/N within an allowable number of times of imaging, as being optimal.

7. The aerial imaging plan creation apparatus according to claim 4,
wherein the processor is configured to:
generate a plurality of simulation images corresponding to the plurality of imaging points in accordance with the aerial imaging plan;
calculate the ratio information of all houses in the plurality of simulation images; and
in a case where a plurality of pieces of ratio information are calculated for the same house based on the plurality of simulation images, adopt ratio information indicating a largest imageable region among the plurality of pieces of ratio information as the ratio information of the same house.

8. The aerial imaging plan creation apparatus according to claim 4,
wherein the processor is configured to, in calculating the ratio information of a specific house among the houses that are the objects to be imaged, calculate a ratio between a region of the specific house shown in the simulation image or a region of the specific house that is obstructed by a house in a foreground of the specific house and that is not shown in the simulation image, and a region of the specific house shown in the simulation image in a case where the specific house is not obstructed or is assumed not to be obstructed by the house in the foreground, as the ratio information.

9. The aerial imaging plan creation apparatus according to claim 8,
wherein the region of the house is a region of an outer wall not including a roof.

10. The aerial imaging plan creation apparatus according to claim 1,
wherein the processor is configured to select an aerial imaging plan evaluated as being optimal or suitable from a plurality of aerial imaging plans based on the evaluation.

11. The aerial imaging plan creation apparatus according to claim 1,
wherein the memory stores a plurality of aerial imaging plans, and
the processor is configured to:
set the aerial imaging plan by automatically selecting a predetermined aerial imaging plan from the plurality of aerial imaging plans or receiving manual input of selection of the aerial imaging plan; and
in a case where the set aerial imaging plan is evaluated as being unsuitable, select an aerial imaging plan having a larger number of times of imaging or an aerial imaging plan having a higher ratio of the imageable region of the object to be imaged than the set aerial imaging plan from the plurality of aerial imaging plans and set the selected aerial imaging plan again.

12. The aerial imaging plan creation apparatus according to claim 1,
wherein the processor is configured to:
receive manual input of the aerial imaging plan including the flying route of the flying object and the plurality of imaging points on the flying route and store the received aerial imaging plan in the memory; and
in a case where the aerial imaging plan stored in the memory is evaluated as being unsuitable, automatically correct the aerial imaging plan stored in the memory to an aerial imaging plan having a larger number of imaging points or an aerial imaging plan having a higher ratio of the imageable region of the object to be imaged than the aerial imaging plan stored in the memory and update the aerial imaging plan stored in the memory with the automatically corrected aerial imaging plan.

13. An aerial imaging plan creation method executed by an aerial imaging plan creation apparatus including a memory storing an aerial imaging plan that is set for aerially imaging an imaging region and that includes a flying route of a flying object and a plurality of imaging points on the flying route, and a processor, the method comprising:
via the processor,
a step of performing aerial imaging simulation of the imaging region in accordance with the aerial imaging plan stored in the memory and generating a simulation image corresponding to an actual aerially captured image through the aerial imaging simulation;
a step of calculating, via the processor, for an object to be imaged in the imaging region, ratio information indicating a ratio of an imageable region or a ratio of an unimageable region to an entire imaging region of the object to be imaged based on the simulation image; and
a step of evaluating the set aerial imaging plan based on the ratio information.

14. The aerial imaging plan creation method according to claim 13,
wherein, in the step of generating the simulation image, exterior information related to an exterior of the object to be imaged in the imaging region is acquired, and the simulation image is generated based on three-dimensional information of the imaging point, camera information including a focal length and a posture of a camera mounted on the flying object, and the exterior information of the object to be imaged.

15. The aerial imaging plan creation method according to claim 13,
wherein the object to be imaged is a house, and
in the step of calculating the ratio information, the ratio information of all houses in the imaging region is calculated.

16. The aerial imaging plan creation method according to claim 15,
wherein, in the step of calculating the ratio information, in a case where the ratio information is an appearance ratio indicating the ratio of the imageable region to the entire imaging region of the object to be imaged, the appearance ratios of all houses in the imaging region are calculated, and
in the step of evaluating the aerial imaging plan, in a case where the number of houses in the imaging region is denoted by N, and the number of houses for which the appearance ratio greater than or equal to a first threshold value is calculated among the houses in the imaging region is denoted by Na, the set aerial imaging plan is evaluated as being suitable in a case where Na/N is greater than or equal to a second threshold value.

17. The aerial imaging plan creation method according to claim 15,
wherein, in the step of calculating the ratio information, the ratio information of all houses in a plurality of simulation images corresponding to the plurality of imaging points is calculated in accordance with the aerial imaging plan, and
in a case where a plurality of pieces of ratio information are calculated for the same house based on the plurality of simulation images, ratio information indicating a largest imageable region among the plurality of pieces of ratio information is adopted as the ratio information of the same house.

18. The aerial imaging plan creation method according to claim 15,
wherein, in the step of calculating the ratio information, in calculating the ratio information of a specific house among the houses that are the objects to be imaged, a ratio between a region of the specific house shown in the simulation image or a region of the specific house that is obstructed by a house in a foreground of the specific house and that is not shown in the simulation image, and a region of the specific house shown in the simulation image in a case where the specific house is not obstructed or is assumed not to be obstructed by the house in the foreground is calculated as the ratio information.

19. The aerial imaging plan creation method according to claim 18,
wherein the region of the house is a region of an outer wall not including a roof.

20. The aerial imaging plan creation method according to claim 13,
wherein the memory stores a plurality of aerial imaging plans,
the method further comprises a step of setting, via the processor, the aerial imaging plan by automatically selecting a predetermined aerial imaging plan from the plurality of aerial imaging plans or receiving manual input of selection of the aerial imaging plan,
in the step of setting the aerial imaging plan, in a case where the set aerial imaging plan is evaluated as being unsuitable in the step of evaluating the aerial imaging plan, an aerial imaging plan having a larger number of times of imaging or an aerial imaging plan having a higher ratio of the imageable region of the object to be imaged than the set aerial imaging plan is set again from the plurality of aerial imaging plans, and
the processor is configured to repeat execution of the step of generating the simulation image, the step of calculating the ratio information, and the step of evaluating the aerial imaging plan in accordance with the aerial imaging plan set again.

21. The aerial imaging plan creation method according to claim 13,
wherein the method further comprises a step of receiving, via the processor, manual input of the aerial imaging plan including the flying route of the flying object and the plurality of imaging points on the flying route and storing the received aerial imaging plan in the memory,
the processor is configured to, in a case where the aerial imaging plan stored in the memory is evaluated as being unsuitable, automatically correct the aerial imaging plan stored in the memory to an aerial imaging plan having a larger number of imaging points or an aerial imaging plan having a higher ratio of the imageable region of the object to be imaged than the aerial imaging plan stored in the memory and update the aerial imaging plan stored in the memory with the automatically corrected aerial imaging plan, and
the processor is configured to repeat execution of the step of generating the simulation image, the step of calculating the ratio information, and the step of evaluating the aerial imaging plan in accordance with the updated aerial imaging plan.
